(19) United States
(12) Patent Application Publication
(10) Pub. No.: US 2012/0209644 A1
(43) Pub. Date: Aug. 16, 2012

(54) COMPUTER-IMPLEMENTED SYSTEM AND METHOD FOR FACILITATING CREATION OF BUSINESS PLANS AND REPORTS

(76) Inventors: Cynthia McCahon, San Francisco, CA (US); Robert C. Peters, San Francisco, CA (US); Romulo Aguilar, JR., (US); Todd Kucker, Modesto, CA (US)

(21) Appl. No.: 13/219,576

(22) Filed: Aug. 26, 2011

Related U.S. Application Data
(60) Provisional application No. 61/443,674, filed on Feb. 16, 2011.

(51) Int. Cl. G06Q 10/00

(52) U.S. Cl. 705/7.11

(57) ABSTRACT

Disclosed herein is a system and method for generating business reports. According to one or more embodiments, information corresponding to a business entity is received. Such information may include a particular category of the business entity and financial information about the business entity. The financial information of the business entity is then compared to financial information collected from one or more businesses in the particular category. A predictive success score for the business entity is then generated based on the comparison. Additionally, descriptive text and financial forecasts, performance reviews and/or a dated Certificate of Performance with unique numbering are also automatically generated.

### CROSS-REFERENCE TO RELATED APPLICATIONS

This application claims benefit of priority to U.S. Provisional Application No. 61/443,674 entitled “Computer-Implemented System and Method For Facilitating Creation of Business Plans and Reports”, filed on Feb. 16, 2011. The aforementioned priority application is hereby incorporated by reference in its entirety.

### TECHNICAL FIELD

Embodiments described herein pertain generally to a computer-implemented system and method for facilitating creation of business plans and reports.

### BRIEF DESCRIPTION OF THE DRAWINGS

FIG. 1 illustrates a system for generating business plans and reports, according to embodiments.

FIG. 2 through FIG. 12 illustrate various interfaces and functionality for use in implementing one or more embodiments described.

FIG. 3 illustrates an interface in which a user is able to register multiple business entities for a service as described, under an embodiment.

FIG. 4 illustrates an interface in which the user can enter basic business information, according to an embodiment.

FIG. 5 illustrates an interface for prompting a user to enter answers to relevant questions for report generation, according to one or more embodiments.

FIG. 6 illustrates a financial information an interface for prompting the user to provide predictive or actual financial information on products and sales, according to one or more embodiments.

FIG. 7 illustrates an interface for forecasting financial results of the business entity, based in part on financial information provided by the user, according to one or more embodiments.

FIG. 8 illustrates an auto ratio analysis interface that is automatically generated to predict performance of the business based on individual financial ratios.

FIG. 9 illustrates an input interface that is generated to include a graphic feature that displays individual business profile performance parameters within a quartile percentage range, under another embodiment.

FIG. 10 illustrates an interface for a performance metric for use in predicting success of the business entity, according to one or more embodiments.

FIG. 11 illustrates a performance review interface, under another embodiment.

FIG. 12 illustrates an input interface in which the user receives a certificate reflecting the user passing criteria set forth by the web service.

FIG. 13 is a block diagram that illustrates a system for implementing one or more embodiments described.

### DETAILED DESCRIPTION

Embodiments include a system and method for providing automated business reporting and planning information. Among other purposes, embodiments such as described enable users (e.g., business owners, operators, entrepreneurs) to develop goals, objects and strategies for business planning. Additionally, according to some embodiments, a system and method is provided to facilitate users in generating a business plan document that satisfies business industry standards.

In one embodiment, a system is implemented to (i) guide users into providing pertinent information, and (ii) generate planning objects, business planning documentation (e.g., formalized business plan), and predictive success metrics. A system such as described may be implemented to provide output in a manner that is responsive to user input, so as to generate and update output and results (e.g., predictive success metrics, business plans) in real-time. The system may be implemented through, for example, software that executes on a user-machine and/or which is provided on a server as part of an online service.

In an embodiment, a system includes an interface and an analysis module. The interface is configured to prompt and guide users into entering pertinent information about a business entity. The information that can be supplied by users includes, but is not limited to: (i) a particular category of the business, (ii) financial information that includes one or more of (a) revenue forecast, (b) actual revenue, (c) profit/loss forecast, or (d) actual profit/loss. Based on the information provided, a predictive score is generated for the business entity based on one or more predetermined success metrics.

According to one or more embodiments, information provided by the user about a particular business entity may be compared to industry data in order to determine how the business entity is performing (or projected to perform) as compared to other businesses that are similar or are of the same type. The comparison with industry data is used to determine the predictive score for the business entity.

As used herein, the terms “programmatic,” “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist on a hardware component independently of other modules/components or a module/component can be a shared element or process of other modules/components, programs or machines. A module or component may reside on one machine, such as on a client or on a server, or may alternatively be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system provided for in this application may require use of memory, processors and network resources, including data ports, and signal lines (optical, electrical, etc.), unless stated otherwise.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

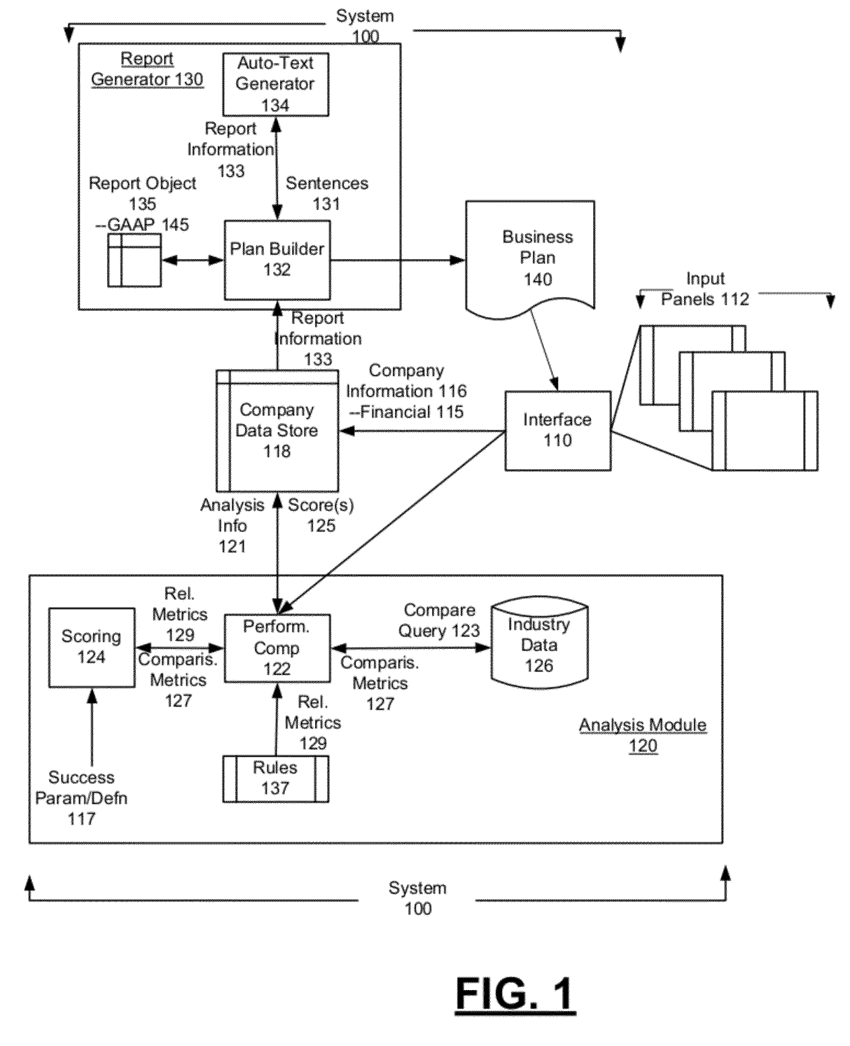

FIG. 1 illustrates a system for generating business plans and reports, according to embodiments. Among other uses, a system such as described can be used to facilitate entrepreneurs and business owners in planning their business. More specifically, system 100 may be used to facilitate business owners in determining their business plan, including determining strategies, goals and objectives. Based on information provided by a user, various business metrics are generated that facilitate the user in understanding strengths and weaknesses of their business planning. Additionally, some embodiments generate one or more predictive success scores to quantify the user's likelihood of success, based on considerations and determinations made by system 100 (including comparisons with other businesses that are deemed to be similar).

Still further, some embodiments provide that system 100 facilitates users in memorializing their business plan. In particular, system 100 may be implemented to programmatically and automatically generate a business plan document from information provided by a user. The business plan document may be automatically generated using information provided by the user. More specifically, the business plan document automatically generates organization, format, and content that is grammatically correct and with structured sentences. The business planning document includes accounting information and content. Among other features, the business plan document may be based on projected or actual financial information provided by the user.

Thus, some embodiments enable the generation of business planning documents to facilitate the business needs of entrepreneurs and business owners. Such business needs may include, for example, loan or investment procurement.

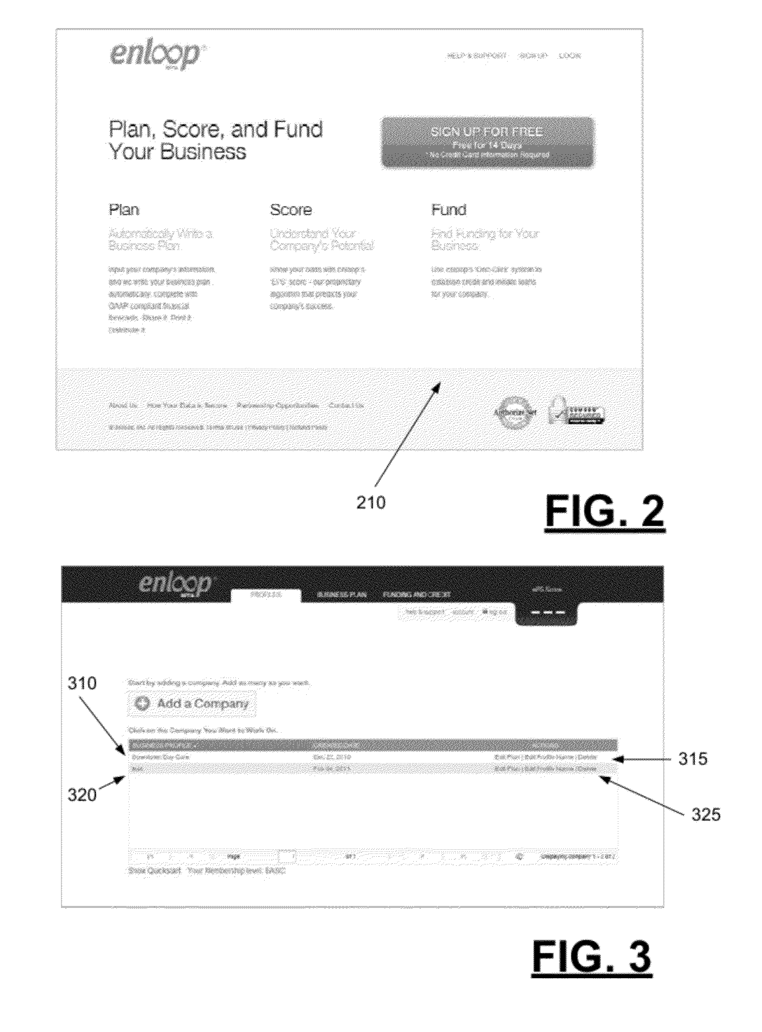

In more detail, system 100 includes an interface module 110, an analysis module 120, and a report generator 130. The interface module 110 generates one or more input panels 112 that prompt and guide a user into providing information about a particular business entity. Among other information, the user may enter a company name, type of business (including sub-categories), geographical location, personnel information (including biographical information about executives and/or other employees, for example), and expected or actual financial information, including profit loss and/or revenue information. Examples of other information that the user may provide are shown in the examples of FIG. 2 through FIG. 11. The panels 112 may guide the user into providing company information and data. For example, the panels 112 may provide the user with choices using graphical features such as pull-down menus, as well as text fields for entering geographical information, and other input fields for entering accounting information. Numerous examples of such panels are provided in the accompanying figures.

In an embodiment, the system 100 is provided as a web service. Accordingly, the interface 110 may generate the input panels 112 as web content that the user interacts with using a browser, or a browser enabled application. The interface module 110 stores company information 116 (including company financial information 115) as a company data store 118. As a web service, the system 100 may store information for numerous business entities provided by numerous businesses and business operators. Thus, processes described with system 100 may be replicated from multiple entities.

The analysis module 120 processes information provided by the user about a particular business entity. In particular, the analysis module 120 performs processes that include (i) comparing the business entity to industry standards, and/or (ii) scoring a business entity based on one or more pre-determined metrics of success. In performing analysis, analysis module 120 utilizes a data store of industry information 126, such as published as Standard Industry Classification (SIC) (also known as ‘NAICS’ (North American Industry Classification)) by the U.S. Census Bureau and other sources. Such information lists averages for businesses by category and sub-category. In one embodiment, the analysis module 120 includes a performance component 122 that compares financial and other information provided by the user via the interface module 110 against industry data 126. The performance component 122 may formulate comparison query (or queries) 123, extracted from provided information to compare against industry standards 126. The extracted information may include, for example, financial information 115, as well as information to categorize the business entity by type. The use of comparison information 123 to compare against industry data 126 provides comparison metrics 127 that compare the business entity to the industry standards 126. As mentioned, the information provided by the user maybe anticipated (e.g., the user is in the planning stage), in which case the comparison metrics 127 are only anticipated. Alternatively, the information provided from the user may be actual data, in which case the comparison metrics 127 are actual and/or predictive of future performance.

As an addition or alternative, performance component 122 may extract or otherwise determine other metrics 129 that are deemed relevant to determinations of success. Such metrics 129 may be defined by, for example, rules and considerations 137 that can be defined by experts in particular categories of businesses. The metrics 129 may be based in part on, for example, success or education level of the executive team or business operator, information known about a particular business segment to experts that may not be reflected in industry data (or historically known), geographic specific considerations, accounting for trends in business and various other factors. In this way, the relevant metrics 129 may be defined by rules and/or expert input.

The analysis module 120 includes a scoring component 124 that utilizes the comparison and relevant metrics 127, 129 in order to generate one or more predictive success scores 125 for the business entity. According to one or more embodiments, the success score 125 is predictive of the success of the business entities, based on comparisons to industry standards, as well as other metrics determined or defined from other sources. The following success definitions or parameters 117 may be used in determining facets of success: profitability prediction, prediction that business entity would be acquired, prediction that business entity would stay in business for X number of years, and/or prediction that the business entity would receive financing (loan or equity). According to one or more embodiments, scoring component 124 uses financial information 115 as a basis for determining success scores 125. Such financial information may be compared against industry data 126 to identify how the particular business entity compares to the industry norm for the same category of business.

Additionally, the scoring component 124 includes business type or category specific weights and algorithms for specific industries. For example, sales forecasts, expenses, profit and loss, financial ratios (e.g., liquidity ratios) may comprise variables or parameters that affect the algorithmic determination of the predictive scores 125, particularly as to how the variables compare to industry norms. Other metrics include management parameters, including past success and/or educational background of the executive or management team (or operator) for the entity. The weights assigned to the various variables, as well as identification of those which are actually used in determining predictive success score, may be affected by, for example, the business category type, as well as other considerations such as current economic environment and geographic considerations.

The interface module 110 is also configured to trigger the analysis module 120 in performing its computations. The result is that input from the user results in real-time updates to the output of the analysis module 120. For example, the analysis component 120 may determine information after a required set of information is entered by the user through the panels 112. Additionally, embodiments realize that the user may interact with system 100 in order to plan, adjust and update their business plan (including goals, objectives). When the user makes such adjustments, the analysis module 120 may recalculate its determinations in a manner that is responsive to the user input.

Information determined by the analysis module 120 (“analysis information 121”) can be stored in association with the company information 116 in the company data store 118. The analysis information 121 includes the predictive score(s) 125. The report generator 130 may access the company data store 118 in order to obtain information for report generation and output.

As mentioned, a particular type of report that can be generated from the report generator 130 corresponds to a business plan document 140. More specifically, under some embodiments, the interface module 110 is designed to present the user with features to facilitate input of data that can be converted and otherwise presented in a report. In particular, the interface module 110 may prompt the user to enter information that can be conveyed in a formal business plan document 140. Under one embodiment, plan builder 132 uses company report information 133 from company store 118. The company report information 133 includes select portions of company information 116 (e.g., executive biographical information), accounting or financial information 115, and analysis information 121 (optionally including success scores 125).

The plan builder 132 implements a report object 135 that specifies formatting, organizational structure, and other aspects of a formal business plan. Additionally, report generator 130 may include intelligence, displayed as auto text generator 134, which generates sentences 131 from report information 133. The auto text generator 134 may implement, for example, a series of if/then logic statements, which substitute company information into grammatically correct sentences 131. According to embodiments, the user does not specify the actual sentences that comprise much of the business plan. With the exception of, for example, portions such as executive biographies, much of the content (e.g., text, accounting information, and/or outlines) of the business plan document 140 is generated using programmatically and automatically generated sentences 131. The plan builder 132 structures sentences 131 into the business plan document 140. The business plan document 140 can be output to the user to facilitate the user in, for example, procuring financing, discussing business ideas with peers, or facilitating the user in memorializing his or her goals and objectives.

In generating the business plan document 140, one or more embodiments provide that the plan builder 132 presents accounting information (as provided by the user through input interface 110, and/or through analysis output 121). The report object 135 used to generate the business plan document 140 may include specifications 145 for formatting and content.

FIG. 2 through FIG. 12 illustrate various interfaces and functionality for use in implementing one or more embodiments described with respect to FIG. 1 above. FIG. 2 illustrates an interface 210 for system 100 when implemented as a web service. For example, a user may operate a web browser to navigate to a website, on which system 100 is implemented. The user may enter information about one or more business entities once an account with the service is established. Information provided by the user can be maintained online, and the user has the ability to modify or update information about a particular entity. To access the service, the user may operate a login and password. As an alternative, embodiments described herein may be provided as a stand-alone or client type environment. For example, functionality described with embodiments provided herein may be provided in part, or entirely on a client terminal.

FIG. 3 illustrates that a particular user may have multiple business entities that have profiles through the web service. For example, one user may plan or operate multiple entities 310 and 320. The user may access a particular interface to select one of the business entities that he/she wishes to review, analyze, and/or generate reports.

As shown in FIG. 3, each business entity 310 and 320 may have one or more corresponding options 315 and 325 to assist the user in accessing and/or editing information about each of the entities. For example, a user may be able to edit information corresponding to a particular entity, edit a profile name associated with the business entity and/or delete information about a particular business entity.

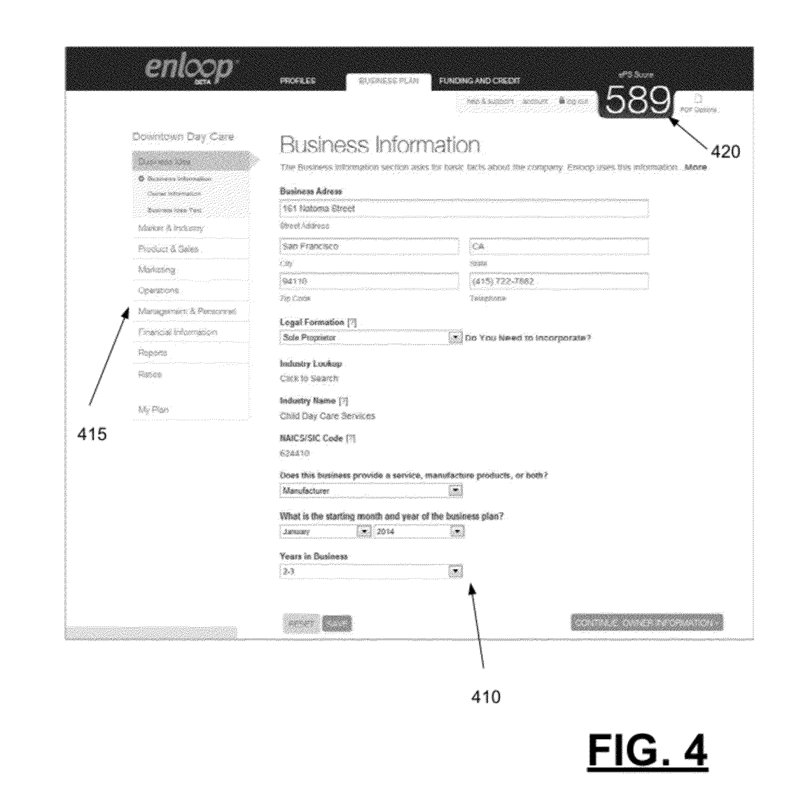

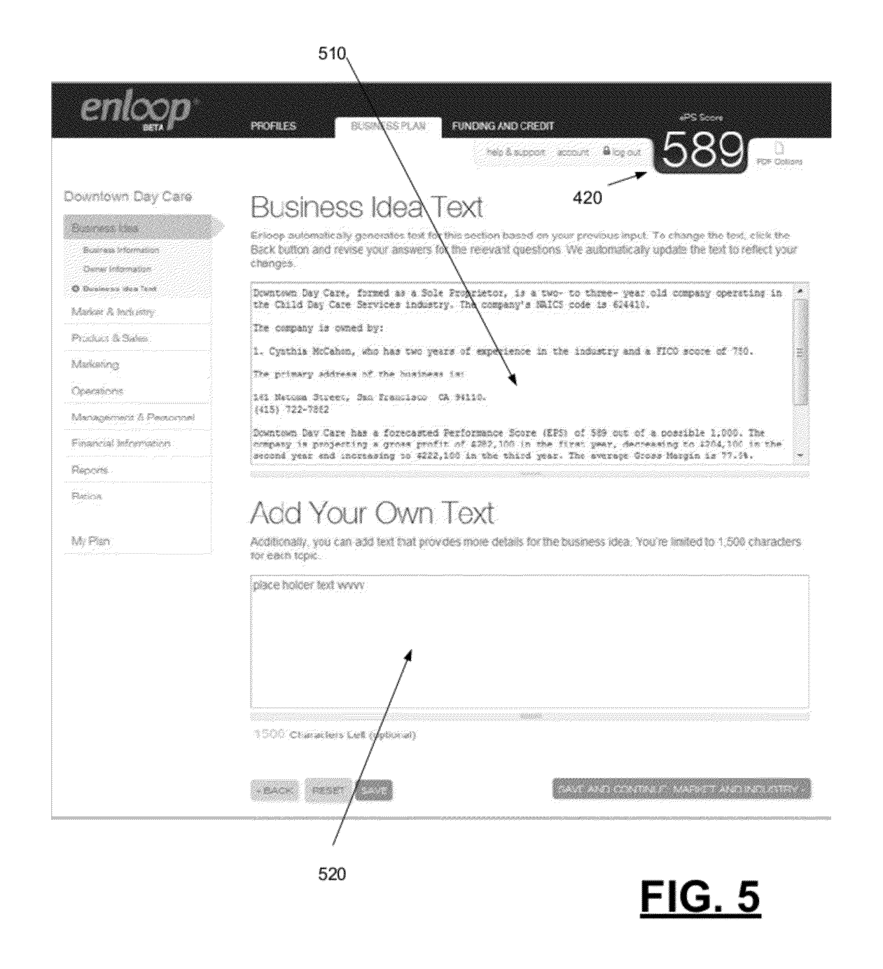

FIG. 4 illustrates a panel 410 in which the user can enter basic business information. According to an implementation shown, when a user selects a business entity, such as, for example business entity 310 (FIG. 3), the user is presented a main business information panel 410 within a framework. The framework enables the user to navigate to different topics where the user can enter and/or edit information and/or see results based on the information. The framework includes subcategories 415 that include additional panels to guide and prompt the user into entering necessary information for generating reports and providing scoring.

As mentioned with an embodiment of FIG. 1, embodiments utilize information provided by the user to generate predictive success scores. Once information is provided by the user through interaction with the service, a predictive success score 420 may be presented on various panels for the user. The user can after information in one or more of the panels 415 in order to adjust the predictive success score 420. In certain embodiments, the success score 420 can be adjusted and provided to the user in real-time based on the information added or edited by the user. As shown, the predictive success score 420 (e.g., 589) is displayed to the user on the business page, which can serve as a starting point in the sequence of panels that the user can view and interact with.

According to embodiments, the predictive success score 420 is a probabilistic measurement of failure risk/likelihood of success for the business. In the implementation provided, the predictive success score 420 is provided on a scale of 1 to 1000, with a higher number indicating a higher probability of success. Success may be defined in a variety of ways, such as described above (e.g., ability for the business to achieve profitability, ability for the business to be sold for profit, ability for the business to procure financing).

FIG. 5 illustrates an input interface for prompting a user to enter answers to relevant questions for report generation according to one or more embodiments. A text field 510 may include customized text derived from user interaction. Thus, at least some of the text provided in the text field 510 may be programmatically generated. Other text may be manually entered by the user. In one embodiment, the text may be based on previous input. The user can change information entered in, for example, text input field 520 in order to change the text that is programmatically generated and presented to the user in the text field 510.

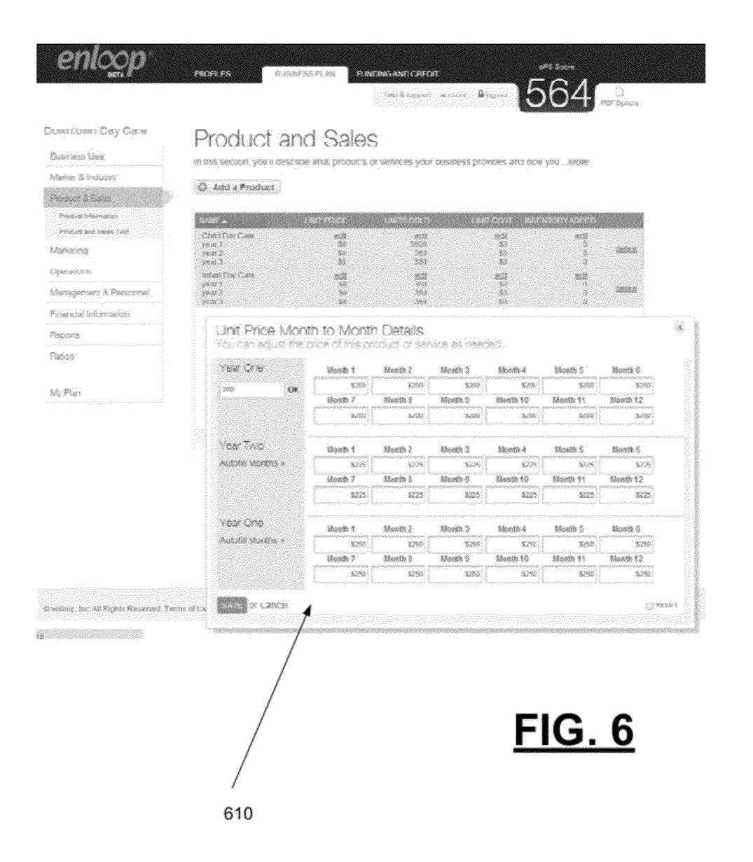

FIG. 6 illustrates a financial information panel for prompting the user to provide predictive or actual financial information on products and sales, according to one or more embodiments. The panel 610 may prompt the user to input some financial information, and may use that information to auto fill other information in the panel 610. For example, the user may enter annual revenue information for a particular year (predictive or actual) and that information is subsequently provided to and displayed in one or more additional years provided on the panel 610. Furthermore, the entered financial information may be maintained for report generation and output.

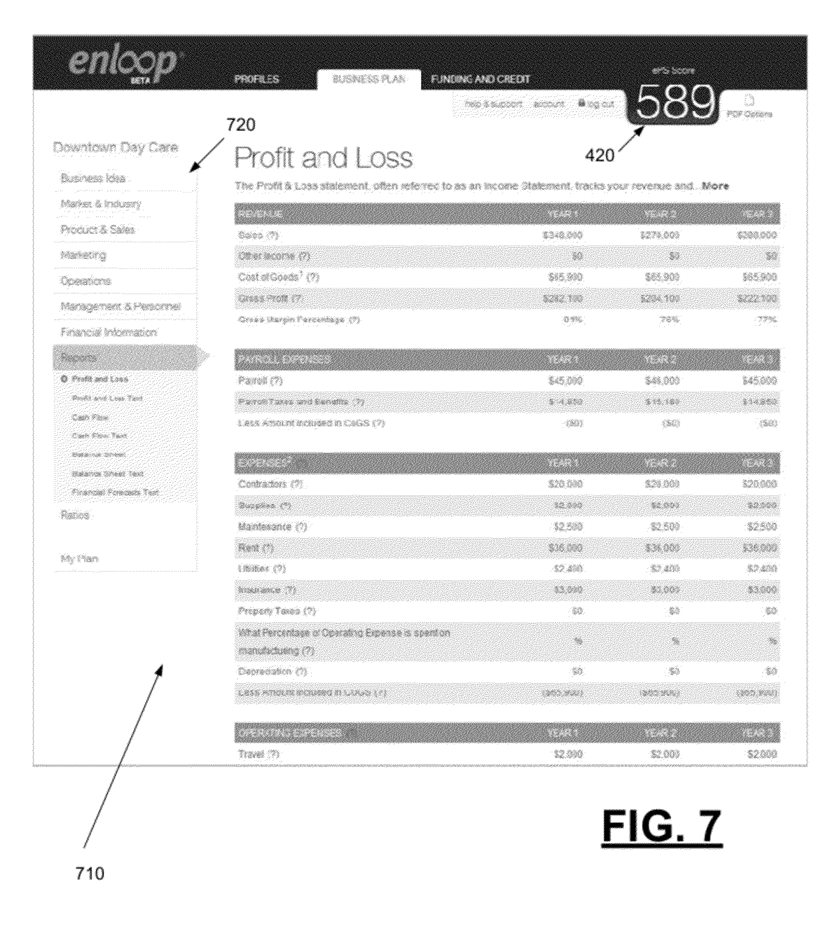

FIG. 7 illustrates a panel 710 for forecasting financial results of the business entity, based in part on financial information provided by the user, according to one or more embodiments. According to an embodiment, an auto forecast technique is implemented to automatically prepare financial forecasts. The financial forecast shown in the panel 710 may be determined in real-time based on user input (i.e., company information 116 (FIG. 1)).

In the example provided, a financial forecast report includes a three-year pro forma forecast with 36-month detailed views of a profit and loss pro forma forecast, a cash flow pro forma forecast, a balance sheet pro forma forecast, and the ratios pro forma forecast. In some embodiments, the forecast information provided in the panel 710 may be updated automatically when the user interacts with data variables provided to other panels. For example, the panels may be arranged in the planning sequence, as identified by the topical heading tabs 720 on the left side of the interface. As the user manipulates certain sections of the input, various outcomes may be affected and updated in real-time, such as financial forecast and/or predictive scoring 420.

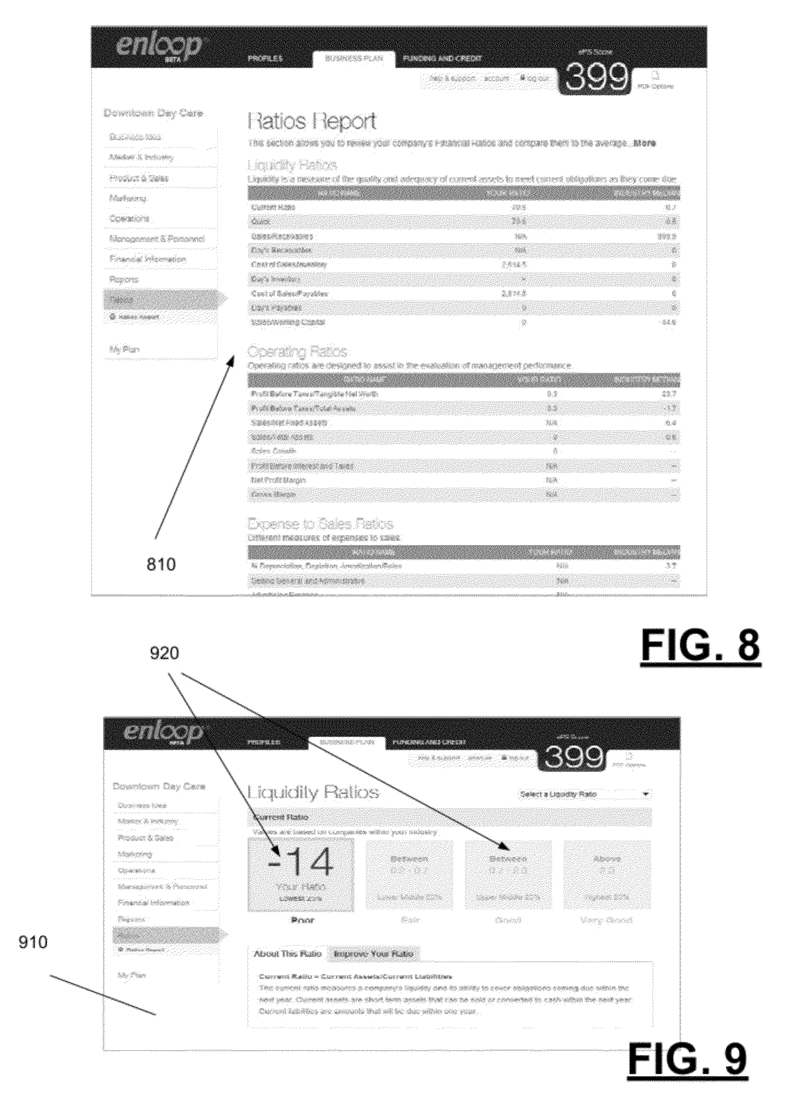

Various predictive performance parameters and metrics may be determined based on information provided from the user. FIG. 8 illustrates an auto ratio analysis panel 810 that is automatically generated to predict performance of the business based on individual financial ratios. The financial ratios may be calculated from the analysis module 120, based on established metrics for an industry.

The analysis module 120 also generates metrics to evaluate the business entity as compared to other businesses that are of same category, or otherwise deemed similar. With reference to FIG. 9, a panel 910 is generated to include a graphic feature 920 that displays individual business profile performance parameters within a quartile percentage range. The performance (or expected performance) of the business under individual accounting ratio is preselected as being relevant to a particular user. Qualitative expressions may accompany the numeric values in the graphic feature 920. In the example shown, the individual ratios are presented and described as “Poor,” “Fair,” “Good” or “Very Good” based on, for example, a comparison to a dataset representative of the business profiles industry average for a particular ratio.

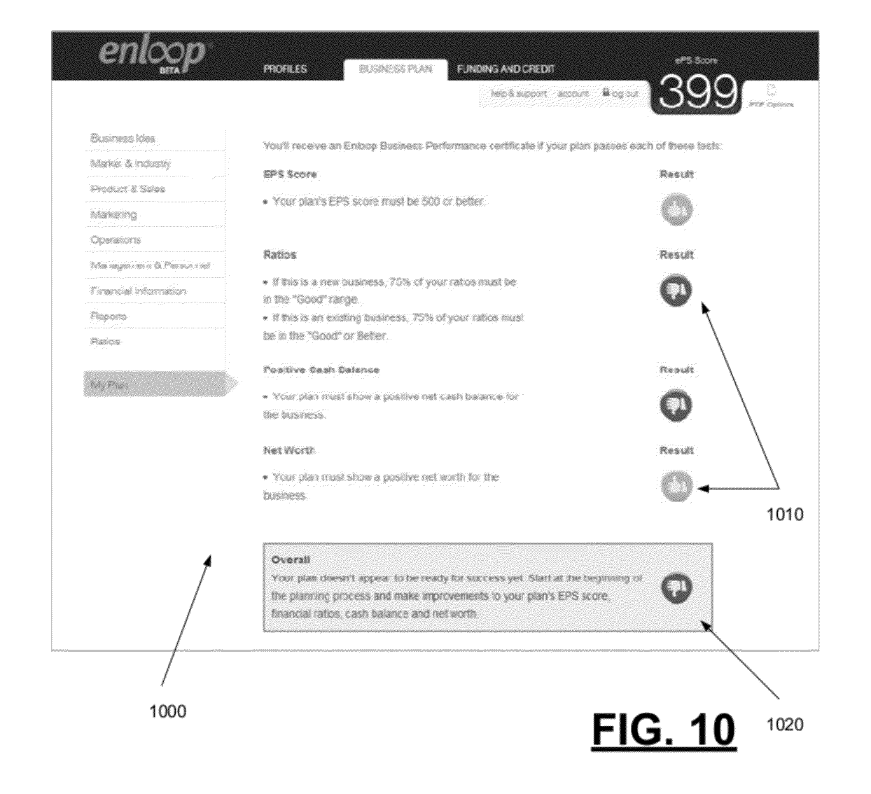

FIG. 10 illustrates another performance metric 1000 for use in predicting success of the business entity, according to one or more embodiments. A performance evaluator parameter provides users estimates of a likelihood of failure or success for business profiles that have undergone a business planning process. Based on the combined analysis of various predictive scores 1010, such as, for example, performance score(s), ratio analysis, cash balance and net worth, the business profile is assigned to either pass or fail result 1020. If the business profile is deemed to fail, the user may be directed back to sections of the business planning sequence that require improvement in order to receive the pass result. Thus, some of the panels provided to the user may display information that prompt the user to revisit his planning strategy based on success or failure predictions.

In certain embodiments, as the user edits and/or alters data in the revisited panels, the pass or fail result 1020 may be updated in real-time accordingly. Thus, if a business entity received a failing result, the user may be able to more accurately determine which areas of the business plan need to be improved to obtain a passing result.

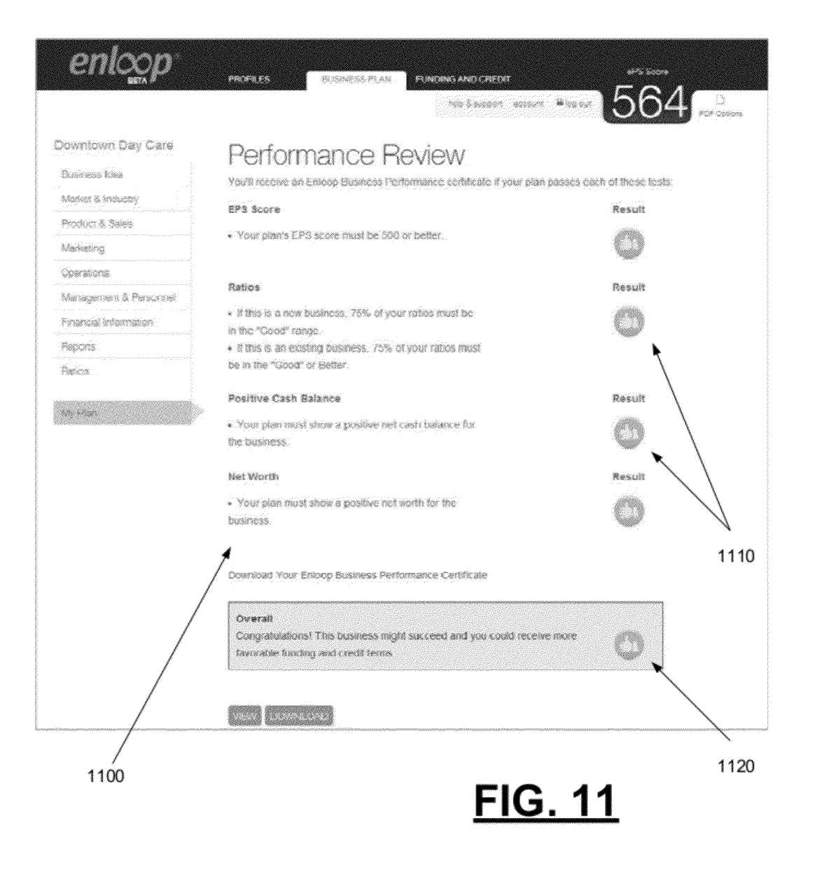

FIG. 11 illustrates a performance review panel 1100 similar to that shown in FIG. 10, except that based on the combined analysis of various predictive scores 1110, such as, for example, performance score(s), ratio analysis, cash balance and net worth, the result shown in the panel has a “Pass” result 1120. According to one or more embodiments, if the requirements for receiving all of “Pass” results are achieved by the user, the user may receive a certification from the web service that reflects the advanced planning performed by the user.

As described with various embodiments, an output of the system 100 is a business plan document 140 which can be generated in electronic or paper format. According to one or more embodiments, the business plan document 140 can be generated when the user has achieved a certain satisfactory level in the business plan. With reference to FIG. 9, for example, the business plan document 140 may be provided as an option to the user in response to the user having passed the various achievement objectives and performance review panel.

The user can view and download a complete business plan document 122 in real-time. In some variations, a document can be made available for viewing and downloading during the entire business planning sequence. Moreover, some embodiments provide that the document updates automatically in real time when the user interacts with the panels to provide new information or data. For example the user may select from the tabs in the planning sequence, change information, and have the business plan automatically updated to reflect the changed information. Specific examples of information that the user can change include, for example, type of Corporation (S versus C corp.), financial information, and business expenses and cost. In addition to changing the business plan document 140 (FIG. 1), as mentioned with other embodiments, predictive success parameters may also be altered based on updated user information. These updates may also be updated in real-time. For example the predictive success score ‘564’ may reflect real-time input from the user.

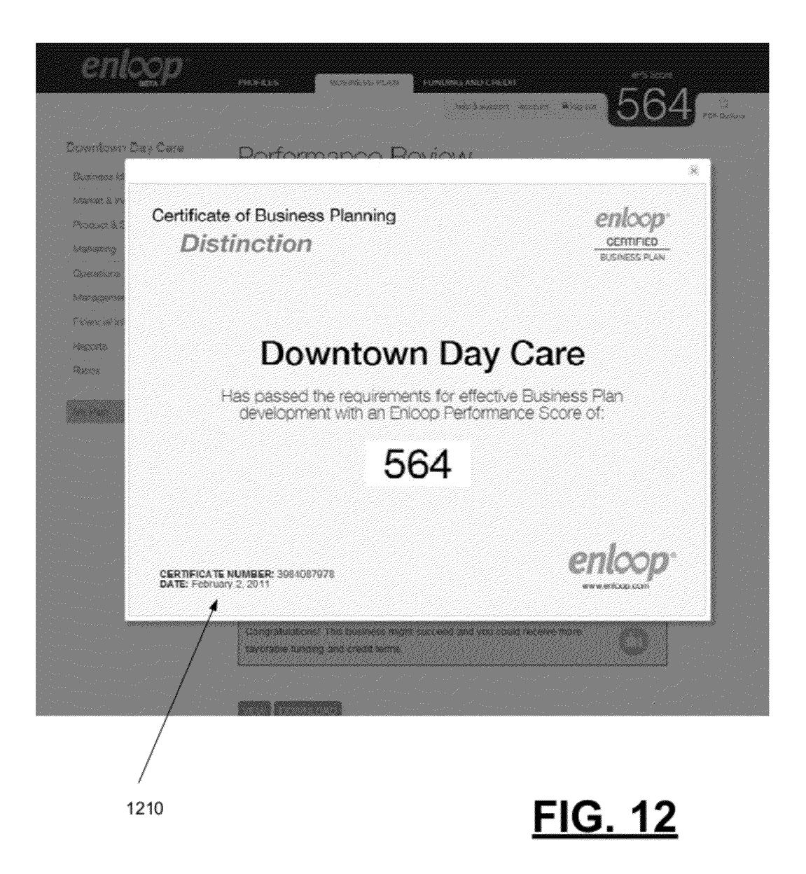

FIG. 12 illustrates a panel 1210 in which the user receives a certificate reflecting the user passing criteria set forth by the web service. The certificate may display a performance score, which corresponds to a unique identifying number and the date certificate was generated. The certificate may be generated in real-time based on a business profile's actual performance in that instance.

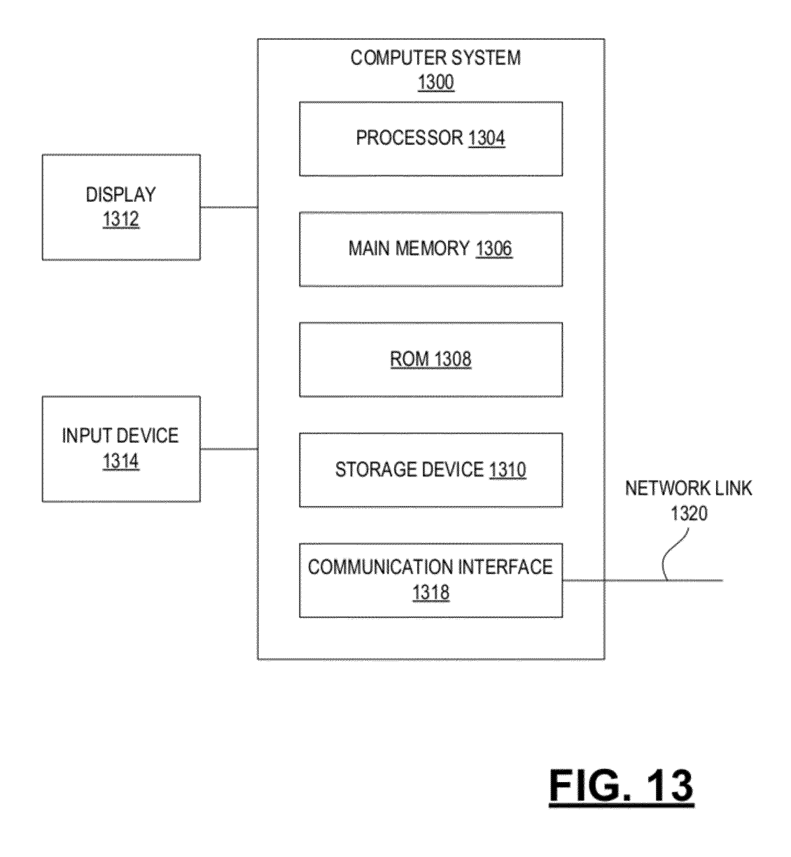

In an embodiment, one or more components of the system 100 (FIG. 1) may be implemented on or using a computer system. FIG. 13 is a block diagram that illustrates a computer system 1300 upon which one or more embodiments may be implemented. In an embodiment, computer system 1300 includes processor 1304, main memory 1306, ROM 1308, storage device 1310, and communication interface 1318. Computer system 1300 includes at least one processor 1304 for processing information. Computer system 1300 also includes a main memory 1306, such as a random access memory (RAM) or other dynamic storage device, for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device for storing static information and instructions for processor 1304. A storage device 1310, such as a magnetic disk or optical disk, is provided for storing information and instructions.

Computer system 1300 may be coupled to a display 1312, such as a cathode ray tube (CRT), a LCD monitor, or a television set, for displaying information to a user. An input device 1314, including alphanumeric and other keys, is coupled to computer system 1300 for communicating information and command selections to processor 1304. Other non-limiting, illustrative examples of input device 1314 include a mouse, a trackball, or cursor direction keys for communicating direction information and command selections to processor 1304 and for controlling cursor movement on display 1312. While only one input device 1314 is depicted in FIG. 13, embodiments disclosed herein may include any number of input devices 1314 coupled to computer system 1300.

One or more embodiments are related to the use of computer system 1300 for implementing the techniques described herein. According to one embodiment, those techniques are performed by computer system 1300 in response to processor 1304 executing one or more sequences of one or more instructions contained in main memory 1306. Such instructions may be read into main memory 1306 from another machine-readable medium, such as storage device 1310. Execution of the sequences of instructions contained in main memory 1306 causes processor 1304 to perform the process steps described herein. In alternative embodiments, hard-wired circuitry may be used in place of or in combination with software instructions to implement embodiments of the invention. Thus, embodiments disclosed herein are not limited to any specific combination of hardware circuitry and software.

The term “machine-readable storage medium” as used herein refers to any medium that participates in storing instructions which may be provided to processor 1304 for execution. Such a medium may take many forms, including but not limited to, non-volatile media and volatile media. Non-volatile media includes, for example, optical or magnetic disks, such as storage device 1310. Volatile media includes dynamic memory, such as main memory 1306.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 1304 for execution. For example, the instructions may initially be carried on a magnetic disk of a remote computer. The remote computer can load the instructions into its dynamic memory and send the instructions over a network link 1320 to computer system 1300.

Communication interface 1318 provides a two-way data communication coupling to a network link 1320 that is connected to a local network. For example, communication interface 1318 may be an integrated services digital network (ISDN) card or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through a local network to a host computer or to data equipment operated by an Internet Service Provider (ISP).

Computer system 1300 can send messages and receive data, including program code, through the network(s), network link 1320 and communication interface 1318. For example, a server might transmit a requested code for an application program through the Internet, a local ISP, a local network, subsequently to communication interface 1318. The received code may be executed by processor 1304 as it is received, and/or stored in storage device 1310, or other non-volatile storage for later execution.

In various embodiments, system 1300 is implemented on a server for devices such as personal computers, portable computers, and mobile devices. The system 1300 may be operated as a shared platform, such as one that includes a web application operating on a device (and which communicates with a corresponding server application). In one implementation, the system 100 may be implemented in whole or in part by use of a mobile web application.

Although illustrative embodiments have been described in detail herein with reference to the accompanying drawings, variations to specific embodiments and details are encompassed by this disclosure. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer implemented method for generating business reports, the method comprising:
providing a user interface configured to receive information about a business entity, the information including one or more of (i) a particular category of the business entity and (ii) financial information about the business entity, wherein the financial information includes one or more of (a) a revenue forecast, (b) actual revenue, (c) a profit/loss forecast, or (d) actual profit/loss information;
comparing the financial information of the business entity to financial information collected from one or more businesses in the particular category; and
generating a predictive success score for the business entity based, at least in part, on the comparison.

2. The method of claim 1, wherein the information also includes one or more of (i) a class of the business entity, (ii) a geographic location of the business entity, or (iii) one or more management parameters associated with the business entity.

3. The method of claim 1, wherein the predictive success score is weighted based on one or more of (i) the category of the business entity, (ii) geographic location of the business entity, (iii) economic environment, or (iv) one or more management parameters associated with business entity.

4. The method of claim 1, further comprising generating a business plan document for the business entity based on the information.

5. The method of claim 4, further comprising automatically generating text content for the business plan document from the information, including generating a series of grammatically correct sentences that convey the received information.

6. The method of claim 1, further comprising automatically updating the predictive success score in real-time when the information is updated or altered by a user.

7. The method of claim 1, wherein the financial information further includes expected or actual monthly revenue and/or monthly costs.

8. The method of claim 1, wherein comparing the financial information of the business entity to financial information collected from one or more businesses in the particular category includes calculating one or more predictive performance ratios of the business entity.

9. The method of claim 1, further comprising assigning a potential successes metric to the business entity based, at least in part, on the predictive success score.

10. A computer system comprising:
a memory; and
one or more processors coupled to the memory, wherein the one or more processors are programmed to:
provide a user interface configured to receive information about a business entity, the information including one or more of (i) a particular category of the business entity, and (ii) financial information about the business entity, wherein the financial information includes one or more of (a) a revenue forecast, (b) actual revenue, (c) a profit/loss forecast, or (d) actual profit/loss information;
compare the financial information of the business entity to financial information collected from one or more businesses in the particular category; and
generate a predictive success score for the business entity based, at least in part, on the comparison.

11. The computer system of claim 10, wherein the computer system provides an online service from which the interface is provided to a user.

12. The computer system of claim 10, wherein the one or more processors are further programmed to generate a business plan document based on the received information.

13. The computer system of claim 12, wherein the one or more processors are further programmed to automatically generate text content for the business plan document from the information, including a series of grammatically correct sentences that convey the received information.

14. The computer system of claim 10, wherein the one or more processors are further programmed to automatically update the predictive success score in real-time when the information is updated or altered by a user.

15. The computer system of claim 10, wherein the one or more processors are further programmed to assign a potential successes metric to the business entity based, at least in part, on the predictive success score.

16. The computer system of claim 10, wherein the one or more processors are further configured to weigh the predictive success score based on one or more of (i) the category of the business entity, (ii) geographic location of the business entity, (iii) economic environment, or (iv) one or more management parameters associated with business entity.

17. A computer storage medium encoding computer executable instructions that when executed by one or more processors, cause the one or more processors to perform steps comprising:
providing a user interface configured to receive information about a business entity, the information including one or more of (i) a particular category of the business entity and (ii) financial information about the business entity, wherein the financial information includes one or more of (a) a revenue forecast, (b) actual revenue, (c) a profit/loss forecast, or (d) actual profit/loss information;
comparing the financial information of the business entity to financial information collected from one or more businesses in the particular category; and
generating a predictive success score for the business entity based, at least in part, on the comparison.

18. The computer storage medium of claim 17, further comprising instructions for automatically updating the predictive success score in real-time when the information is updated or altered by a user.

19. The computer storage medium of claim 17, further comprising instructions for generating a business plan document for the business entity based on the information.

20. The computer storage medium of claim 19, further comprising instructions for automatically generating text content for the business plan document from the information, including generating a series of grammatically correct sentences that convey the received information.
